(19) United States
(12) Patent Application Publication
(10) Pub. No.: US 2015/0177099 A1
(43) Pub. Date: Jun. 25, 2015

(54) METHOD, COMPUTER PROGRAM PRODUCT & SYSTEM

(71) Applicant: AKTIEBOLAGET SKF, Göteborg (SE)

(72) Inventors: Keith Hamilton, Fife (GB); Brian Murray, Aberdeen (GB)

(21) Appl. No.: 14/395,504

(22) PCT Filed: Mar. 27, 2013
(86) PCT No.: PCT/EP2013/056477

§ 371 Date: Oct. 20, 2014

Related U.S. Application Data
(60) Provisional application No. 61/637,523, filed on Apr. 24, 2012.
(60) Provisional application No. 61/637,568, filed on Apr. 24, 2012.

(51) Int. Cl. G01M 13/04

(52) U.S. Cl. CPC G01M 13/04

(57) ABSTRACT

A method for predicting the residual life of a rolling-element bearing comprising the step of: measuring the magnitude and/or the frequency of occurrence of high frequency stress wave events emitted by rolling contact of the rolling-element bearing, recording the measurement data as recorded data, and predicting the residual life of the rolling-element bearing using the recorded data and an International Organization for Standardization (ISO) rolling-element bearing life model. The accumulated fatigue damage is determined from the measurements of the magnitude and/or the number of high frequency stress wave events emitted by rolling contact of the bearing rather than using the International Organization for Standardization (ISO) rolling-element bearing life model's values for the accumulated fatigue damage.

### CROSS REFERENCE TO RELATED APPLICATIONS

This is a National Stage application claiming the benefit of International Application Number PCT/EP2013/056477 filed on 27 Mar. 2013 (27.03.2013), which claims the benefit of U.S. Provisional Patent Application No. 61/637,523 filed on 24 Apr. 2012 (24.04.2013) and U.S. Provisional Patent Application No. 61/637,568 filed on 24 Apr. 2012 (24.04.2012), all of which are incorporated herein by reference in their entireties.

### TECHNICAL FIELD

The present invention concerns a method, system and computer program product for predicting the residual life of a rolling-element bearing, i.e. for predicting when it is necessary or desirable to service, replace or refurbish (re-manufacture) the rolling-element bearing.

### BACKGROUND OF THE INVENTION

Rolling-element bearings are often used in critical applications, wherein their failure in service would result in significant commercial loss to the end-user. It is therefore important to be able to predict the residual life of a bearing, in order to plan intervention in a way that avoids failure in service, while minimizing the losses that may arise from taking the machinery in question out of service to replace the rolling-element bearing.

The residual life of a rolling-element bearing is generally determined by fatigue of the operating surfaces as a result of repeated stresses in operational use. Fatigue failure of a rolling-element bearing results from progressive flaking or pitting of the surfaces of the rolling-elements and of the surfaces of the corresponding bearing races. The flaking and pitting may cause seizure of one or more of the rolling-elements, which in turn may generate excessive heat, pressure and friction.

Bearings are selected for a specific application on the basis of a calculated or predicted residual life expectancy compatible with the expected type of service in the application in which they will be used. The length of a bearing's residual life can be predicted from the nominal operating conditions considering speed, load carried, lubrication conditions, etc. For example, a so-called “L-10 life” is the life expectancy in hours during which at least 90% of a specific group of bearings under specific load conditions will still be in service. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a bearing is subjected in operational use, so as to be able to detect the first signs of impending failure. This monitoring is often referred to as “condition monitoring”.

Condition monitoring brings various benefits. A first benefit is that a user is warned of deterioration in the condition of the bearing in a controlled way, thus minimizing the commercial impact. A second benefit is that condition monitoring helps to identify poor installation or poor operating practices, e.g., misalignment, imbalance, high vibration, etc., which will reduce the residual life of the bearing if left uncorrected.

European patent application publication EP 1 164 550 describes an example of a condition monitoring system for monitoring statuses, such as the presence or absence of an abnormality in a machine component such as a bearing.

### SUMMARY OF THE INVENTION

An object of the invention is to provide an improved method for predicting the residual life of a rolling-element bearing.

This object is achieved by a method comprising the steps of: measuring the magnitude and/or the frequency of occurrence of high frequency stress wave events (i.e. 100-500 kHz or higher) emitted by rolling contact of the rolling-element bearing, recording the measurement data as recorded data, and predicting the residual life of the rolling-element bearing using the recorded data and an International Organization for Standardization (ISO) rolling-element bearing life model. The accumulated fatigue damage is determined from the measurements of the magnitude and/or the number of high frequency stress wave events emitted by rolling contact of the rolling-element bearing, rather than using said International Organization for Standardization (ISO) rolling-element bearing life model's values for the accumulated fatigue damage.

The expression “high frequency stress wave event” as used in this document is intended to mean a short (i.e. up to 5 milliseconds (ms) in duration, typically 1 ms in duration) “burst” or “envelope” of high frequency stress waves (i.e. 100-500 kHz or higher) that is received as a unit, namely a wave packet. This wave packet may be processed electronically to generate an “envelope” that describes the duration and intensity of stress waves in the wave packet.

The expression “measuring the magnitude and/or the frequency of occurrence of high frequency stress wave events” or “the number of high frequency stress wave events” as used in this document is intended to mean counting the number of spikes (i.e. envelopes) representative of the high frequency stress wave events, i.e. each high frequency stress wave event may be reduced to a spike and the number and magnitude of spikes may be counted. The amount of damage done being done to the bearing may therefore be determined. Alternatively, or additionally the rate at which such high frequency stress wave events occur may be measured, i.e. the number of high frequency stress wave events occurring during a predetermined time period, may be measured to give an indication of how contaminated a rolling element bearing's lubricant is and/or how rapidly the lubricant is becoming contaminated, I,e, the rate at which damage is being done.

According to an embodiment of the invention a raceway factor is used to modify a determined cleanliness factor, the magnitude of which is determined by the severity of the damage indicated by said measurements of the magnitude and/or the frequency of occurrence of vibrations or high frequency stress wave events emitted by rolling contact of said rolling-element bearing (12).

When a rolling-element bearing is used over a long period of time, fatigue is accumulated in its race region. Fatigue causes damage such as flaking in the race region. The nominal residual life of rolling bearings may be estimated using the residual life-evaluating equation provided in ISO 281, which is based on Lundberg and Palmgren's fatigue theory. The calculated value obtained from this equation is effective for a group of bearings and is an important standard in the design stage. However, when this equation is applied to the evaluation of individual bearings, the calculated value of residual life obtained from the ISO 281 rolling-element bearing life model may be incorrect due to the effect of the bearing's operating conditions. Modern, high quality bearings can namely exceed the calculated value of residual life by a considerable margin under favourable operating conditions.

The method proposed by the present invention derives the accumulated fatigue damage from measurements of the magnitude and/or the number of high frequency stress wave events emitted by rolling contact of the bearing, i.e. measured values rather than using the ISO 281 rolling-element bearing life model's assumed or predicted accumulated fatigue damage values. The method according to the present invention therefore enables a more accurate residual life prediction to be made.

Furthermore, the ISO 281 rolling-element bearing life model includes a lubrication cleanliness factor, aiso which allows a corrected nominal residual life (Lnm) to be to be computed as follows:

Lₙₘ=a₁·aᵢₛₒ·L₁₀

where a1 is a correction factor to correct for different life definitions eg. L10, L1 or L50 and aiso is a life modification factor that corrects for the quality of lubrication. aiso is derived from cleanliness factor and lubrication film thickness data provided with the ISO 281 rolling-element bearing life model.

According to an embodiment of the invention a new factor, namely the “raceway factor” is taken into consideration when determining the cleanliness factor and/or lubrication film. The raceway factor is degraded from a value of 1.0 according to empirical rules if condition monitoring, e.g. vibration monitoring, shows the bearing to be damaged or in a failure process. The raceway factor is used to modify the cleanliness factor, i.e. the cleanliness factor derived from measured is multiplied by the raceway factor. The greater the damage indicated by the measurements, the smaller the magnitude of the raceway factor and consequently, the shorter the nominal residual life (Lnm) of the bearing being evaluated. The modified cleanliness factor thereby takes into account the effect of wear or damage that may eventually lead to failure of the bearing.

High frequency stress wave events accompany the sudden displacement of small amounts of material in a very short period of time. In bearings high frequency stress wave events can be generated when impacting, fatigue cracking, scuffing or abrasive wear occurs. The frequency of the stress waves depends on the nature and material properties of the source. An absolute motion sensor, such as an accelerometer, an acoustic emission sensor, or an ultrasonic sensor can be used to detect such high frequency stress wave events and thereby provide important information for assistance in fault detection and severity assessment. Due to the dispersion and attenuation of the high frequency stress wave packet, it is desirable to locate a sensor as near to the initiation site as possible. A sensor may therefore be placed in the vicinity of, or on the bearing housing, preferably in the load zone.

Furthermore, a lubrication film can be compromised by excessive load, low viscosity of the lubricant or contamination of the lubricant with particulate material, or a lack of lubricant. If a lubrication film is compromised in this way, high frequency waves will be emitted by rolling contact of the bearing. The condition of the lubrication film can therefore be assessed by detecting high-frequency stress waves that propagate through the bearing rings and the surrounding structure in the event of a breakdown of the lubrication film. The system according to the present invention thereby allows a residual life prediction to be made using measured values indicative of lubricant quality rather than assumed or predicted lubricant quality values.

According to an embodiment of the invention the magnitude of the raceway factor is determined from empirical data, contained in a database for example and originating in or based on observation or experience of similar or substantially identical rolling-element bearings to the one(s) being monitored, for example using data collected from a plurality of bearings, such as recordings made over an extended period of time and/or based on tests on similar or substantially identical bearings.

According to another embodiment of the invention the ISO rolling-element bearing life model is an ISO 281 rolling-element bearing life model, such as ISO 281:2007.

ISO 281:2007 specifies methods of calculating the basic dynamic load rating of rolling rolling-element bearings within the size ranges shown in the relevant ISO publications, manufactured from contemporary, commonly used, high quality hardened rolling-element bearing steel, in accordance with good manufacturing practice and basically of conventional design as regards the shape of rolling contact surfaces.

ISO 281:2007 also specifies methods of calculating the basic rating life, which is the life associated with 90% reliability, with commonly used high quality material, good manufacturing quality and with conventional operating conditions. In addition, it specifies methods of calculating the modified rating life, in which various reliabilities, lubrication condition, contaminated lubricant and fatigue load of the rolling-element bearing are taken into account.

ISO 281:2007 does not cover the influence of wear, corrosion and electrical erosion on rolling-element bearing life.

ISO 281:2007 is not applicable to designs where the rolling-elements operate directly on a shaft or housing surface, unless that surface is equivalent in all respects to the rolling-element bearing ring (or washer) raceway it replaces.

According to an embodiment of the invention the method comprises the step of determining whether the high frequency stress wave events emitted by rolling contact of the rolling-element bearing arise due to a plurality of fatigue cycles at a single location, or from successive events from different sources on the rolling-element bearing's operating surfaces. This may be done by analyzing data from a plurality of sensors located around the rolling-element bearing.

According to another embodiment of the invention the method includes the step of obtaining identification data uniquely identifying the rolling-element bearing and recording the identification data together with the recorded data. Such a method allows a quantitative prediction of the residual life of a rolling-element bearing to me made on the basis of information providing a comprehensive view of the rolling-element bearing's history and usage.

According to a further embodiment of the invention electronic means is used in the step of recording the data in a database.

According to an embodiment of the invention the rolling bearing may be any one of a cylindrical roller bearing, a spherical roller bearing, a toroidal roller bearing, a taper roller bearing, a conical roller bearing or a needle roller bearing.

According to a further embodiment of the invention the method comprises the step of updating the residual life prediction as the new data is obtained and/or recorded.

The present invention also concerns a computer program product that comprises a computer program containing computer program code means arranged to cause a computer or a processor to execute the steps of a method according to any of the embodiments of the invention, stored on a computer-readable medium or a carrier wave.

The present invention also concerns a system for predicting the residual life of a bearing comprising at least one sensor configured to measure the magnitude and/or the frequency of occurrence of high frequency stress wave events emitted by rolling contact of the rolling-element bearing and a data processing unit configured to record the measurement data as recorded data. The system also comprises a prediction unit configured to predict the residual life of the rolling-element bearing using the recorded data and an International Organization for Standardization (ISO) rolling-element bearing life model, whereby accumulated fatigue damage is determined from the measurements of the magnitude and/or the number of high frequency stress wave events emitted by rolling contact of the bearing, rather than using said International Organization for Standardization (ISO) rolling-element bearing life model's values for the accumulated fatigue damage.

According to an embodiment of the invention a raceway factor is used to modify a determined cleanliness factor, the magnitude of which is determined by the severity of the damage indicated by said measurements of the magnitude and/or the frequency of occurrence of vibrations or high frequency stress wave events emitted by rolling contact of said rolling-element bearing.

According to an embodiment of the invention the system comprises a database of raceway factors determined from empirical data.

According to another embodiment of the invention the ISO rolling-element bearing life model is an ISO 281 rolling-element bearing life model, such as ISO 281:2007.

ISO 281:2007 specifies methods of calculating the basic dynamic load rating of rolling rolling-element bearings within the size ranges shown in the relevant ISO publications, manufactured from contemporary, commonly used, high quality hardened rolling-element bearing steel, in accordance with good manufacturing practice and basically of conventional design as regards the shape of rolling contact surfaces.

ISO 281:2007 also specifies methods of calculating the basic rating life, which is the life associated with 90% reliability, with commonly used high quality material, good manufacturing quality and with conventional operating conditions. In addition, it specifies methods of calculating the modified rating life, in which various reliabilities, lubrication condition, contaminated lubricant and fatigue load of the rolling-element bearing are taken into account.

ISO 281:2007 does not cover the influence of wear, corrosion and electrical erosion on rolling-element bearing life.

ISO 281:2007 is not applicable to designs where the rolling-elements operate directly on a shaft or housing surface, unless that surface is equivalent in all respects to the rolling-element bearing ring (or washer) raceway it replaces.

According to an embodiment of the invention the prediction unit is also configured to determine whether the high frequency stress wave events emitted by rolling contact of the rolling-element bearing arise due to a plurality of fatigue cycles at a single location, or from successive events from different sources on the rolling-element bearing's operating surfaces. This can be done by analyzing data obtained from a plurality of sensors located around the rolling-element bearing.

According to another embodiment of the invention the system comprises an identification sensor configured to obtain identification data uniquely identifying the rolling-element bearing and recording the identification data together with the recorded data.

According to a further embodiment of the invention the data processing unit is configured to electronically record the measurement data as recorded data.

According to another embodiment of the invention the prediction unit is configured to update the residual life prediction as the new data is obtained and/or recorded.

According to a further embodiment of the invention the rolling bearing may be any one of a cylindrical roller bearing, a spherical roller bearing, a toroidal roller bearing, a taper roller bearing, a conical roller bearing or a needle roller bearing.

The method, system and computer program product according to the present invention may be used to predict the residual life of at least one bearing used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention,

FIG. 2 is a flow diagram showing the steps of a method according to an embodiment of the invention, and

FIG. 3 shows a rolling-element bearing, the residual life of which can be predicted using a system or method according to an embodiment of the invention.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

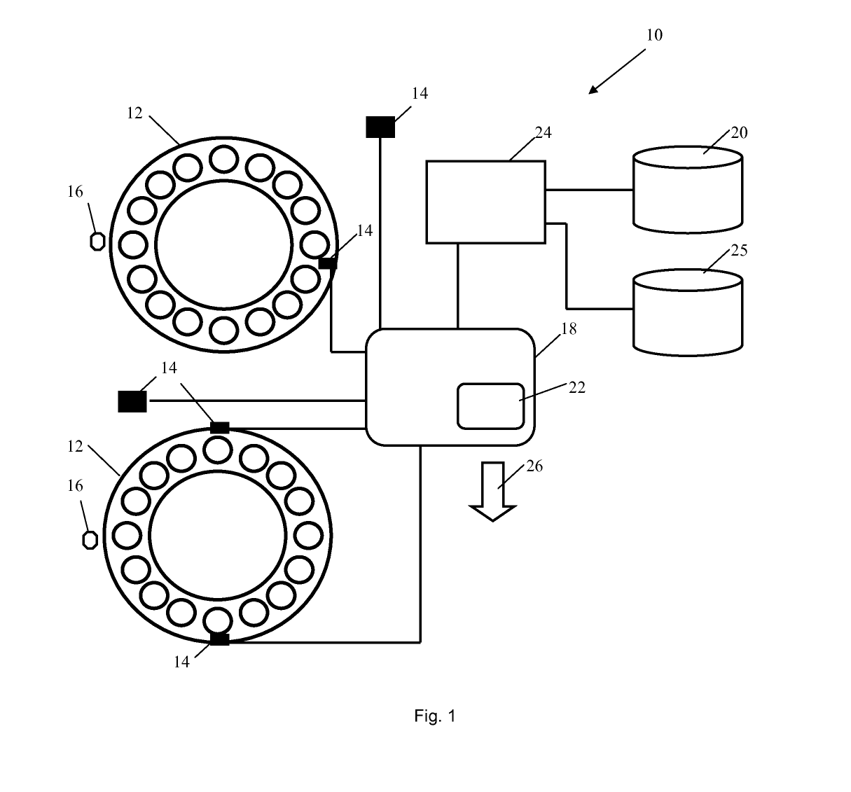

FIG. 1 shows a system 10 for predicting the residual life of a plurality of rolling-element bearings 12 during their use. The illustrated embodiment shows two rolling-element bearings 12, the system 10 according to the present invention may however be used to predict the residual life of one or more rolling-element bearings 12 of any type, and not necessarily all of the same type or size. The system 10 comprises a plurality of sensors 14 configured to measure high frequency stress wave events (i.e. 20 kHz-3 Mz, preferably 100-500 kHz or higher) emitted by rolling contact of the rolling-element bearings 12. One or more sensors 14, such as accelerometers, acoustic emission sensors or ultrasonic sensors are preferably placed as close to the high frequency stress wave initiation site as possible. One or more sensors 14 may be integrated with a rolling-element bearing 12, such as embedded in the rolling-element bearing ring, or placed in the vicinity of the rolling-element bearing 12, such as on or near the bearing housing, preferably in the load zone. Preferably, a plurality of sensors 14 are provided in and/or around each bearing 12.

The system 10 also optionally comprises at least one identification sensor configured to obtain identification data 16 uniquely identifying each rolling-element bearing 12. The identification data 16 may be obtained from a machine-readable identifier associated with a rolling-element bearing 12, and is preferably provided on the rolling-element bearing 12 itself so that it remains with the rolling-element bearing 12 even if the rolling-element bearing 12 is removed to a different location or if the rolling-element bearing 12 is refurbished. Examples of such machine-readable identifiers are markings that are engraved, glued, physically integrated, or otherwise fixed to a rolling-element bearing, or a pattern of protrusions or of other deformations located on the rolling-element bearing. Such identifiers may be mechanically, optically, electronically, or otherwise readable by a machine. The identification data 16 may for example be a serial number or an electronic device, such as a Radio Frequency Identification (RFID) tag, securely attached to the rolling-element bearing 12. The RFID tag's circuitry may receive its power from incident electromagnetic radiation generated by an external source, such as the data processing unit 18 or another device (not shown) controlled by the data processing unit 18.

If an appropriate wireless communication protocol such as that described in IEEE802.15.4 is employed, a new bearing installed on site will announce its presence and software developed for the purpose will communicate its unique digital identity. Appropriate database functionality then associates that identity and location with the previous history of that bearing.

Such identification data 16 enables an end-user or a supplier of a bearing 12 to verify if a particular bearing is a genuine article or a counterfeit product. Illegal manufacturers of bearings may for example try to deceive end-users or Original Equipment Manufacturers (OEMs) by supplying bearings of inferior quality, in packages with a false trademark, so as to give the impression that the bearings are genuine products from a trustworthy source. Worn bearings may be refurbished and then sold without an indication that they have been refurbished and old bearings may be cleaned and polished and sold without the buyer knowing the actual age of the bearings. However, if a bearing is given a false identity, a check of a database of the system according to the present invention may reveal a discrepancy. For example, the identity of a counterfeit product will not exist in the database, or the residual life data obtained under its identification data will not be consistent with the false bearing being checked. The database of the system according to such an embodiment of the present invention in which identification data is obtained, indicates for each legitimate bearing, its age and whether or not the bearing has been refurbished. Thus, the system according to the present invention may facilitate the authentication of a bearing.

The database 20 may be maintained by the manufacturer of the rolling-element bearings 12. Thus, each bearing 12 of a batch of similar or substantially identical rolling-element bearings 12 can be tracked. The residual life data gathered in the database 20 for a whole batch of rolling-element bearings 12 enables the manufacturer to extract further information, e.g., about relationships between types or environments of usage versus rates of change of residual life, so as to further improve the service to the end-user.

The system also comprises a prediction unit 22 configured to predict the residual life of each rolling-element bearing 12 using the recorded data and an ISO rolling-element bearing life model, such as ISO 281:2007, whereby accumulated fatigue damage is determined from the measurements of the magnitude and/or the number of high frequency stress wave events emitted by rolling contact of the rolling-element bearing 12, rather than using said International Organization for Standardization (ISO) rolling-element bearing life model's values for the accumulated fatigue damage.

According to an embodiment of the invention a raceway factor is used to modify a determined cleanliness factor, the magnitude of which is determined by the severity of the damage indicated by said measurements of the magnitude and/or the frequency of occurrence of vibrations or high frequency stress wave events emitted by rolling contact of said rolling-element bearing 12.

According to an embodiment of the present invention the system may comprise a database of raceway factors determined from empirical data 25. The empirical data 25 may for example be provided to a user in the form of look-up tables whose data originates or is based on observation or experience of similar or substantially identical rolling-element bearings to the one(s) being monitored.

It should be noted that not all of the components of the system 10 necessarily need to be located in the vicinity of the rolling-element bearings 12. The components of the system 10 may communicate by wired or wireless means, or a combination thereof, and be located in any suitable location. For example, a database containing the recorded data 20 may located at a remote location and communicate with at least one data processing unit 18 located in the same or a different place to the rolling-element bearings 12 by means of a server 24 for example.

The at least one data processing unit 18 optionally pre-processes identification data 16 and the signals received from the sensors 14. The signals may be converted, re-formatted or otherwise processed so as to generate service life data representative of the magnitudes sensed. The at least one data processing unit 18 may for example be configured to use data reduction methodology. For example, a digital time waveform may be captured by each sensor and transformed into the frequency domain via a fast Fourier Transform (FFT) analysis. In addition to spectral analysis, the transforming of the time waveform into an autocorrelation function may provide great assistance in diagnostics, Autocorrelation allows an analyst to determine the dominant periodic events within a stress wave analysis waveform. In doing so a waveform can be cleaned up allowing an analyst to see which sources are the main contributors to such waveforms.

The at least one data processing unit 18 may be arranged to communicate identification data 16 and the high frequency stress wave data via a communication network, such as a telecommunications network or the Internet for example. A server 24 may log the data in a database 20 in association with identification data 16, thus building a history of the rolling-element bearing 12 by means of accumulating service life data over time.

It should be noted that the at least one data processing unit 18, the prediction unit 22 and/or the databases 20, 25 need not necessarily be separate units but may be combined in any suitable manner. For example a personal computer may be used to carry out a method concerning the present invention.

A prediction unit 22 may be configured to update a residual life prediction using new data concerning measurements of high frequency stress wave events emitted by rolling contact of a bearing 12. Such updates may be made periodically, substantially continuously, randomly on request or at any suitable time.

Once a prediction 26 of the residual life of a rolling-element bearing 12 has been made, it may be displayed on a user interface, and/or sent to a user, bearing manufacturer, database and/or another prediction unit 22. Notification of when it is advisable to service, replace or refurbish one or more rolling-element bearings 12 being monitored by the system 10 may be made in any suitable manner, such as via a communication network, via an e-mail or telephone call, a letter, facsimile, alarm signal, or a visiting representative of the manufacturer.

The prediction 26 of the residual life of a rolling-element bearing 12 may be used to inform a user of when he/she should replace the rolling-element bearing 12. Intervention to replace the rolling-element bearing 12 is justified, when the cost of intervention (including labour, material and loss of, for example, plant output) is justified by the reduction in the risk cost implicit in continued operation. The risk cost may be calculated as the product of the probability of failure in service on the one hand, and the financial penalty arising from such failure in service, on the other hand.

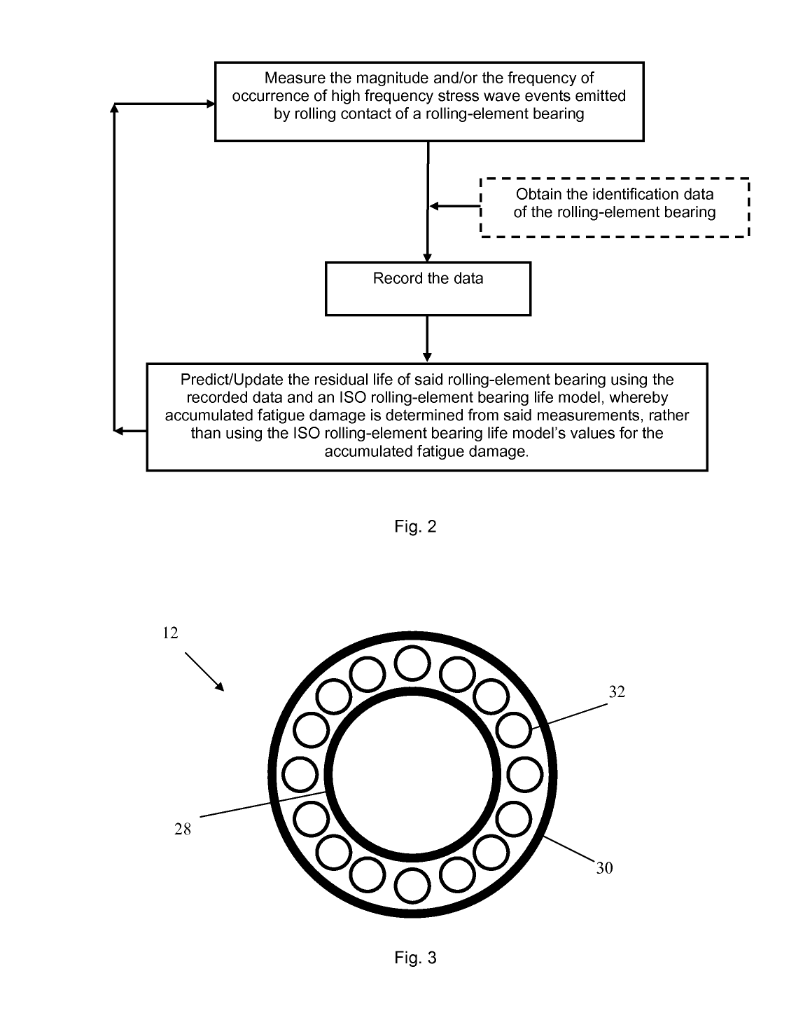

FIG. 2 shows the steps of a method according to an embodiment of the invention. The method comprises the steps of measuring the magnitude and/or the frequency of occurrence of high frequency stress wave events emitted by rolling contact of a bearing, optionally obtaining data uniquely identifying the rolling-element bearing, recording the measurement data (and optionally the identification data) as recorded data, and predicting the residual life of the rolling-element bearin using the recorded data and an ISO rolling-element bearing life model. The accumulated fatigue damage is determined from the measurements of the magnitude and/or the number of high frequency stress wave events emitted by rolling contact of the rolling-element said bearing. The lubrication cleanliness factor in the ISO rolling-element bearing life model is modified by a raceway factor, the magnitude of which is determined by the severity of the damage indicated by the measurements of the magnitude and/or the frequency of occurrence of high frequency stress wave events emitted by rolling contact of a rolling-element bearing.

FIG. 3 schematically shows an example of a rolling-element bearing 12, the residual life of which can be predicted using a system or method according to an embodiment of the invention. FIG. 3 shows a rolling-element bearing 12 comprising an inner ring 28, an outer ring 30 and a set of rolling-elements 32. The inner ring 28 and/or outer ring 30 of a bearing 12, the residual life of which can be predicted using a system or method according to an embodiment of the invention, may be of any size and have any load-carrying capacity. An inner ring 28 and/or an outer ring 30 may for example have a diameter up to a few metres and a load-carrying capacity up to many thousands of tonnes.

Further modifications of the invention within the scope of the claims would be apparent to a skilled person. Even though the claims are directed to a method, system and computer program product for predicting the residual life of a bearing, such a method, system and computer program product may be used for predicting the residual life of some other component of rotating machinery, such as a gear wheel.

1. A method for predicting the residual life of a rolling-element bearing comprising steps of:
measuring at least one of a magnitude and a frequency of occurrence of high frequency stress wave events emitted by rolling contact of said rolling-element bearing,
recording said measurement data as recorded data, and
predicting the residual life of said rolling-element bearing using said recorded data and an International Organization for Standardization (ISO) rolling-element bearing life model, whereby accumulated fatigue damage is determined from said measurements of the magnitude and/or the number of frequency of high frequency stress wave events emitted by rolling contact of said bearing, rather than using said International Organization for Standardization (ISO) rolling-element bearing life model's values for the accumulated fatigue damage.

2. A method according to claim 1, wherein a raceway factor is used to modify a determined cleanliness factor, the magnitude of which is determined by the severity of the damage indicated by said measurements of at least one of the magnitude and the frequency of occurrence of one of vibrations or high frequency stress wave events emitted by rolling contact of said rolling-element bearing.

3. A method according to claim 2, wherein the magnitude of said raceway factor is determined from empirical data.

4. A method according to claim 1, wherein said ISO rolling-element bearing life model is an ISO 281 rolling-element bearing life model.

5. A method according to claim 1, further comprising a step of determining whether said high frequency stress wave events emitted by rolling contact of said rolling-element bearing arise due to one of a plurality of fatigue cycles at a single location, or from successive events from different sources on the rolling-element bearing's operating surfaces.

6. A method according to claim 1, further comprising a step of obtaining identification data uniquely identifying said rolling-element bearing and recording said identification data together with said recorded data.

7. A method according to claim 1, further comprising a step of recording said data in a database using an electronic data recording device.

8. A method according to claim 1, further comprising a step of updating said residual life prediction as said new data is at least one of obtained and recorded.

9. A computer program product, comprising a computer program containing computer program code arranged to cause one of a computer or a processor to execute steps of a method comprising steps of:
measuring at least one of a magnitude and a frequency of occurrence of high frequency stress wave events emitted by rolling contact of said rolling-element bearing,
recording said measurement data as recorded data, and
predicting the residual life of said rolling-element bearing using said recorded data and an International Organization for Standardization (ISO) rolling-element bearing life model, whereby accumulated fatigue damage is determined from said measurements of the magnitude and/or the number of frequency of high frequency stress wave events emitted by rolling contact of said bearing, rather than using said International Organization for Standardization (ISO) rolling-element bearing life model's values for the accumulated fatigue damage;
wherein the computer program code is stored on a computer-readable medium or a carrier wave.

10. A system for predicting the residual life of a rolling-element bearing comprising:
at least one sensor configured to measure at least one of the magnitude and the frequency of occurrence of high frequency stress wave events emitted by rolling contact of said rolling-element bearing,
a data processing unit configured to record said measurement data as recorded data, and
a prediction unit configured to predict the residual life of said bearing using said recorded data and a mathematical residual life prediction model, whereby accumulated fatigue damage is determined from said measurements of the magnitude and/or the number of high frequency stress wave events emitted by rolling contact of said bearing, rather than using said International Organization for Standardization (ISO) rolling-element bearing life model's values for the accumulated fatigue damage.

11. A system according to claim 10, wherein a raceway factor is used to modify a determined cleanliness factor, the magnitude of which is determined by the severity of the damage indicated by said measurements of the magnitude and/or the frequency of occurrence of vibrations or high frequency stress wave events emitted by rolling contact of said rolling-element bearing.

12. A system according to claim 11, further comprising a database of raceway factors determined from empirical data.

13. A method according to claim 10, wherein said ISO rolling-element bearing life model is an ISO 281 rolling-element bearing life model.

14. A system according to claim 10, wherein said prediction unit is also configured to determine whether said high frequency stress wave events emitted by rolling contact of said rolling-element bearing arise due to one of a plurality of fatigue cycles at a single location, or from successive events from different sources on said rolling-element bearing's operating surfaces.

15. A system according to claim 10, further comprising an identification sensor configured to obtain identification data uniquely identifying said rolling-element bearing and recording said identification data together with said recorded data.

16. A system according to claim 10, wherein said data processing unit is configured to electronically record said measurement data as recorded data.

17. A system according to claim 10, wherein said prediction unit is configured to update said residual life prediction as said new data is obtained and/or recorded.
